(19) United States
(12) Patent Application Publication
(10) Pub. No.: US 2005/0191378 A1
(43) Pub. Date: Sep. 1, 2005

(54) Tri-flow head assembly

(76) Inventor: Jeffrey W. Brenyer, McPherson, KS (US)

Correspondence Address: CHASE LAW FIRM L.C, 4400 COLLEGE BOULEVARD, SUITE 130, OVERLAND PARK, KS, 66211, US

(21) Appl. No.: 10/787,344

(22) Filed: Feb. 26, 2004

(51) Int. Cl. B29C 47/26; B29C 47/28

(52) U.S. Cl. 425/133.1

(57) ABSTRACT

A head assembly for presenting a three layer material flow includes primary and secondary housings for presenting a first interior layer and a second intermediate layer of the three layer flow. A downstream melt distributor melds the first and second material layers into a combined material flow for deposit of a third exterior layer about the combined flow. The melt distributor includes a sinuous channel for directing the material of the outer layer into points of discharge about the combined material flow. A scroll-like distributor communicates with the discharge points for directing the third material into an annular path about the combined flow, and a subsequent melding of the third material with the combined flow. The resulting three layer flow is directed to a downstream die assembly.

### BACKGROUND OF THE INVENTION

This invention relates to an extrusion head assembly and, more particularly, to an assembly which efficiently presents a concentric, multilayered material flow to a downstream die assembly.

In order to produce a tri-layered material product, three layers of the material, e.g., an extruded thermoplastic resin/resin combination or three resin material layers, must be presented. The head assembly receives resin and resin with foaming agent from upstream sources, which are then heated, combined and directed to a downstream die assembly. Upon passage of the flow through the die assembly, a multi-layered product is presented having exterior and interior resin layers from the same source with a foamed layer therebetween.

Various problems may arise as the material flow, if not balanced, may produce an unstable flow. In order to achieve uniformity in the layers, the flow velocity must be controlled. However, flow velocity is difficult to adjust absent a controlled increase in temperature and pressure which, if not regulated, can result in undesirable, unstable flows. For example, an unstable resin flow may release gases, e.g., chlorine, resulting in stagnation, hardening and burning within the head assembly which results in undesirable imperfections.

The flow imbalances, if not corrected or compensated, can present an uneven wall thickness in the final product. An imbalanced flow can cause turbulence which can create a disruptive flow. Such disruptive flows can result in further aberrations such as an undesirable weld/rupture line in the finished product, rough surfaces on the finished product and discolorations along the surface of the final product. Thus, absent a continuous and special operator attention to the material flows, it is very difficult to obtain a desired uniform quality in the finished product. I have addressed a dual layer balanced flow in my U.S. Pat. No. 5,240,396, which is incorporated by reference herein.

In some instances the exterior layer of the product need not meet the same strict specifications as the interior layer and the intermediate layer, e.g., the resin and foam layers in drain waste pipes. In such pipes, the outer layer needs only a material coating, e.g., for protection against ultraviolet rays and to close the exterior cells of the foamed layer. However, the interior resin and intermediate foam layers must be in accordance with stricter specifications to insure product strength, to prevent waste leakage therethrough as well as present desirable sound deadening characteristics. Thus, it is desirable to present a head assembly which presents a balanced, geometric flow for the interior and intermediate layers along with the economic advantage of a cost-effective resin coating therearound.

In response thereto I have invented a tri-flow head assembly which produces a geometrically balanced flow of the inner resin layer and intermediate foam layer and an exterior resin layer coated therearound. My assembly generally comprises primary and secondary melt housings which provide for a flow of the inner resin and intermediate foam layers in a controlled, balanced flow therethrough. An offset input assembly injects the exterior resin material into a downstream scroll-type melt distributor housing subsequent to a combination of these inner and intermediate layers. This scroll distributor directs the exterior resin, as received from a single input port, into a plurality of sinuous paths which deposits the resin into a scroll-like channel for an ultimate annular melding of the resin about the combined layer. As such a combined flow of three material layers is presented to a downstream die assembly.

It is therefor a general object of this invention to provide a head assembly for efficiently presenting a plurality of material layers to a downstream die assembly.

It is another general object of this invention to provide a head assembly, as aforesaid, which presents inner resin and intermediate foamed resin flows with an exterior resin layer coated therearound.

Still another object of this invention is to provide a head assembly, as aforesaid, which efficiently melds inner and outer material flows with an intermediate material layer therebetween.

A further object of this invention is to provide a head assembly, as aforesaid, which directs the interior and intermediate flows through the head assembly in a geometrically balanced flow.

Another object of this invention is to provide a head assembly assembly, as aforesaid, which presents three material flows that can be efficiently monitored, regulated and conducted through the head assembly.

Still another object of this invention is to provide a head assembly, as aforesaid, which can be easily communicated with upstream extruders and a downstream die assembly.

A particular object of this invention is to provide a head assembly, as aforesaid, presenting a combined flow of first and second material layers for a subsequent surround by an exterior resin coating therearound.

Another particular object of this invention is to provide a head assembly, as aforesaid, presenting a scroll-like distributor assembly which enhances a coating of an exterior material about a previously formed material flow.

A more particular object of this invention is to provide a manifold assembly, as aforesaid, which receives the material from an upstream inlet and efficiently directs the material into sinuous paths for a downstream annular melding about a material flow.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a central diagrammatic view of the tri-flow head assembly with three material flows therethrough being shown in section lines.

FIG. 2 is a view of the tri-flow head assembly, along a longitudinal centerline, showing the flow paths within the primary melt housing, the secondary melt housing and the scroll-type melt distributor comprising an upstream manifold and downstream manifold.

FIG. 3 is a view, taken along line 3-3 in FIG. 2, illustrating, as viewed downstream, the upstream face of the primary melt housing.

20 FIG. 3A is a view, taken along line 3A-3A in FIG. 3, showing the flow channels for the foam flow.

FIG. 3B is a view, taken along line 3B-3B in FIG. 3, showing the flow channel for the interior resin flow.

FIG. 4 is a view, taken along line 4-4 in FIG. 2, illustrating, as viewed upstream, the downstream face of the primary melt housing.

FIG. 5 is a view, taken along line 5-5 in FIG. 2, illustrating, as viewed upstream, the downstream face of the secondary melt housing.

FIG. 6 is a view, taken along line 6-6 in FIG. 2, illustrating, as viewed downstream, the upstream face of the upstream manifold portion of the scroll distributor housing with the mandrel pin ring and flow ring removed.

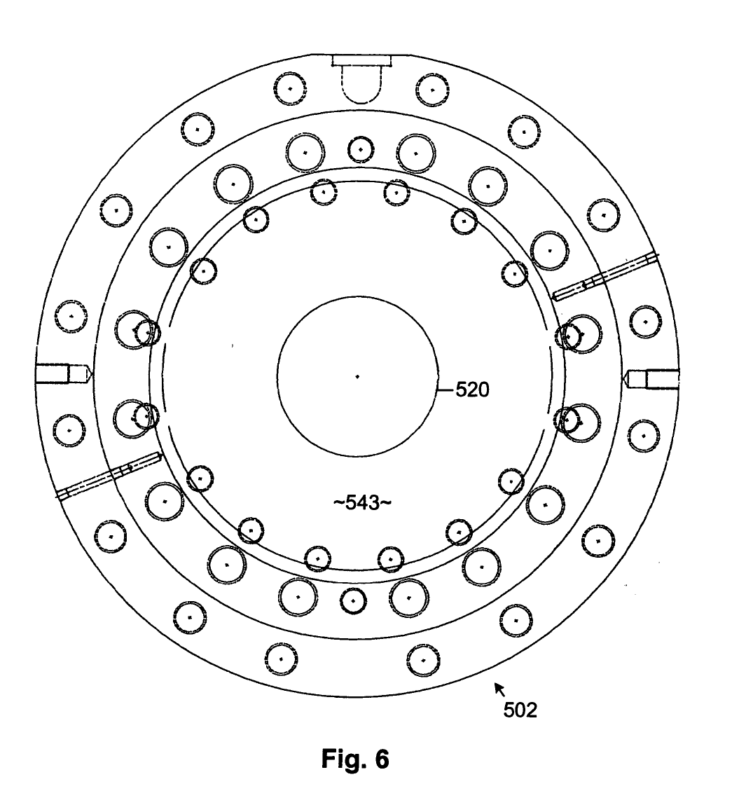

FIG. 7 is a view, taken along line 7-7 in. FIG. 2, illustrating, as viewed upstream, the downstream face of the upstream manifold.

FIG. 8 is a view, taken along line 8-8 in FIG. 2, illustrating, as viewed downstream, the upstream face of the downstream manifold of the scroll distributor housing.

FIG. 9 is a view, taken along line 9-9 in FIG. 2, illustrating, as viewed upstream, the downstream face of the downstream manifold.

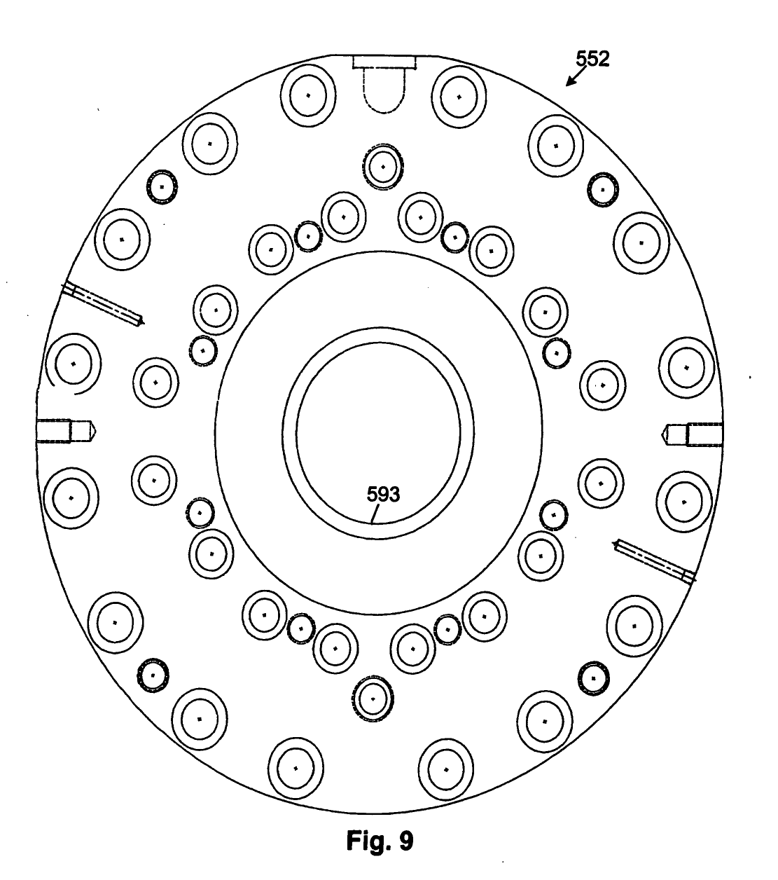

### DESCRIPTION OF THE PREFERRED EMBODIMENT

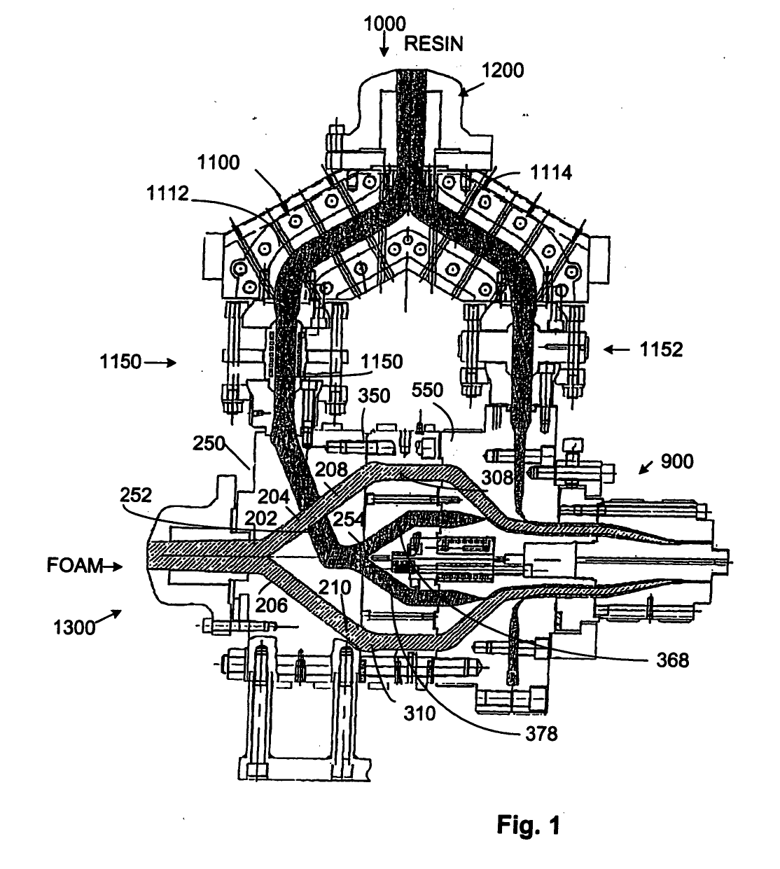

Turning more particularly to the drawings, FIG. 1 shows my head assembly as comprising a resin input assembly 1200, foamed resin input assembly 1300, a primary melt housing 250, a secondary melt housing 350, a scroll melt housing 550, and die housing 900.

The resin input assembly 1200 receives the melted resin from an upstream resin melt source 1000 which is delivered to a Y-block 1 100 producing first and second resin paths 1112, 1114. Resin paths 1112, 1114 are directed through restrictors 1150, 1152 allowing for regulated control of the downstream resin melt flow.

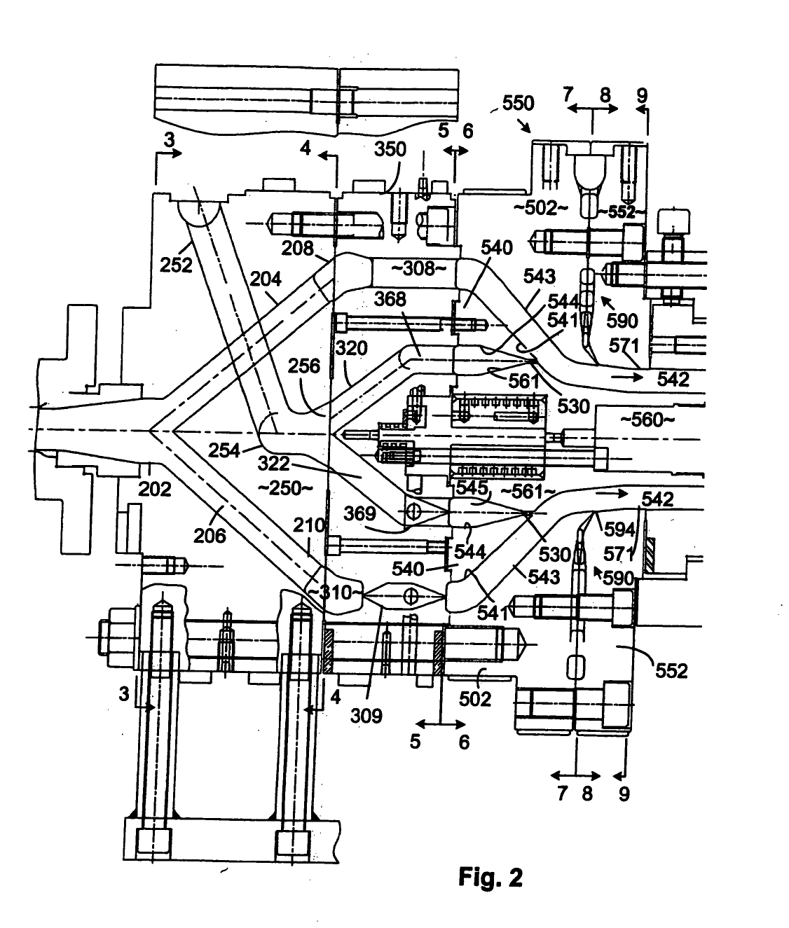

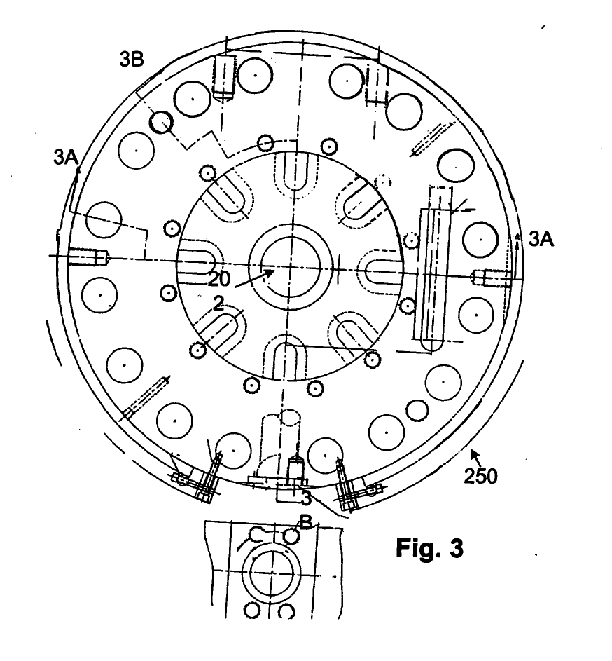

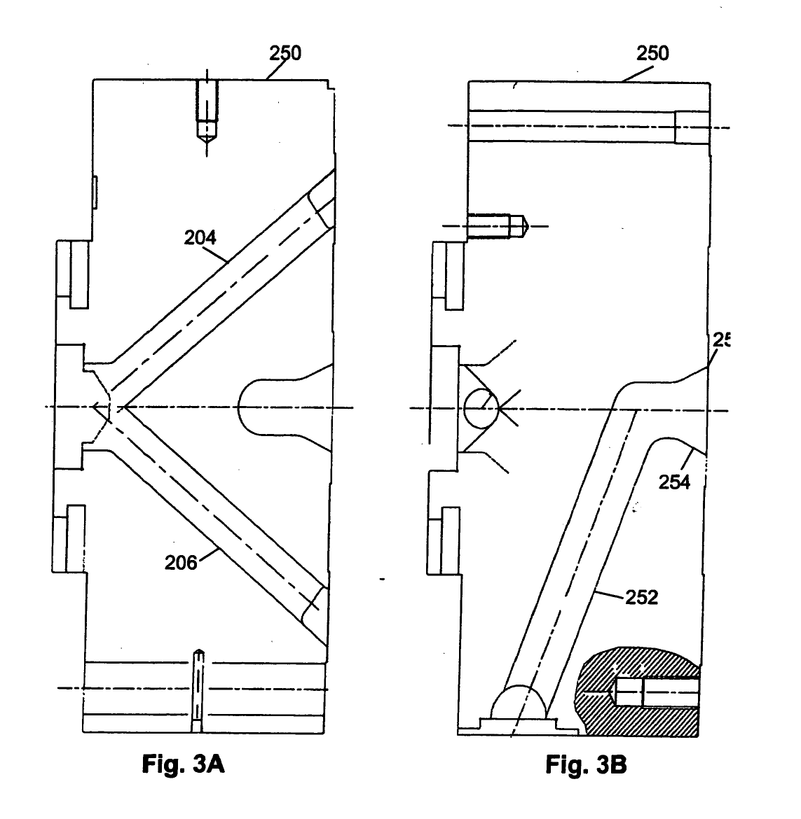

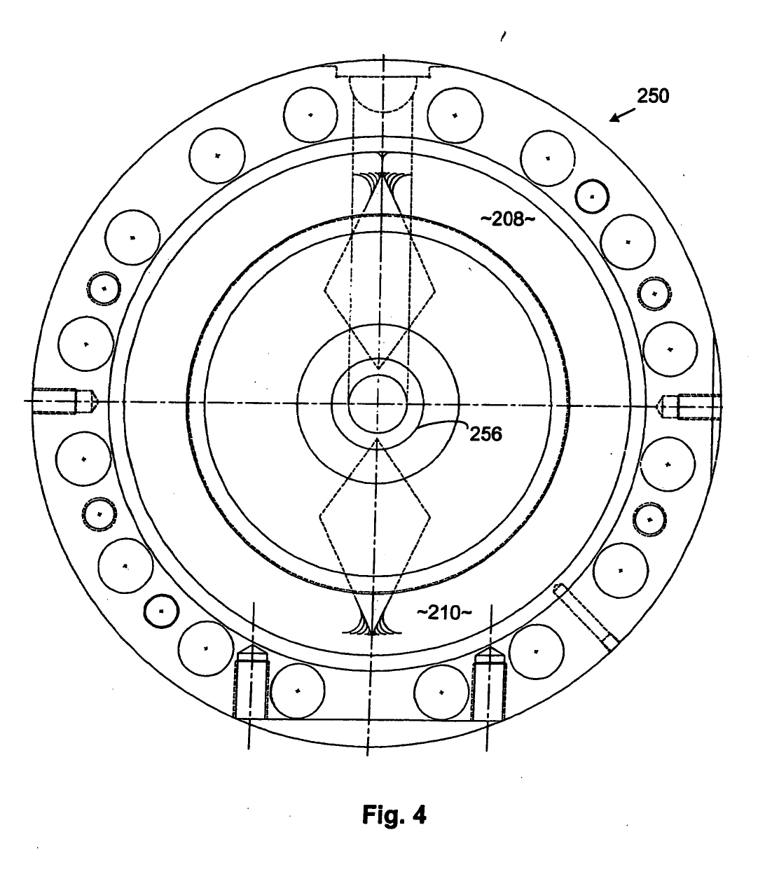

The foamed resin input assembly 1300 directs an extruded foam from an upstream source into bore 202 in primary melt distributor block 250 (FIG. 2). This bore 202 branches 204, 206 (FIG. 3A) downstream for directing the foam from bore 202 to first 208 and second annular channels 210 transitioning to a full annular flow channel before the downstream face (FIG. 4) of the primary melt distributor housing 250.

The resin path 1112 directs a resin flow into offset bore 252 (FIG. 3B) which extends through the primary housing 250 and communicates with bore 254 which terminates at outlet port 256 on the downstream face (FIG. 4) of the primary melt housing 250. Accordingly, at this downstream face is presented a generally full annular foamed resin flow from channels 208, 210. This full channel surrounds an inside resin flow from port 256. (Reference is made to my incorporated U.S. Pat. No. 5,240,396, which shows apparatus for producing a combined material flow.)

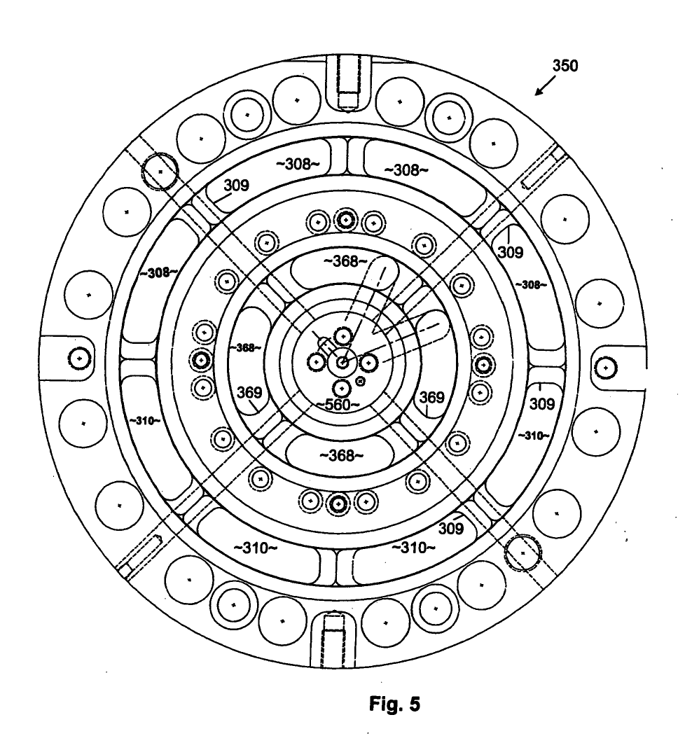

Connected downstream to the primary melt housing 250 is a secondary melt housing 350 (FIG. 5). This melt housing presents an upstream face having annular foamed resin flow channel comprising, as viewed, upper and lower channel ports 308, 310 for communication with the upper and lower foam 208, 210 channel portions in housing 250.

Concurrently, the inner resin flow is directed from outlet 256 through channel flow ports 368 towards the downstream face of the secondary melt housing 350 (FIG. 5). As such a generally annular resin flow and a spatially displaced generally annular foamed resin flow is presented at the downstream face of secondary housing 350.

Attached to the secondary melt housing 350 is a scroll melt housing 550 comprising an upstream manifold 502 and a downstream manifold 552. As shown in FIG. 2 a flow ring 540 and mandrel pin body 560 is positioned within this melt housing 550. The flow ring 540 presents an annular surface 541 which cooperates with the annular surface 543 within upstream manifold 502 to present a flow path 542 for the foamed resin flow. This flow path is extended downstream as formed by the exterior surface 561 of the pin body 560 and an interior surface 571 of the downstream manifold 552. Also, the foam ring 540 presents an annular surface 544 which cooperates with exterior surface 561 of pin body 560 to form a resin flow path 545.

Accordingly, at the upstream face of the upstream manifold 502 of housing 550 a flow of foamed resin from the above foam ports in paths 308, 310 is then directed through annular path 542. Concurrently, the inner resin layer flow is directed from the paths 368 through path 544. At path juncture 530 a melding of the flow of the inner resin layer and foamed resin layer results, which is directed through path 542 to the downstream face of upstream manifold 502.

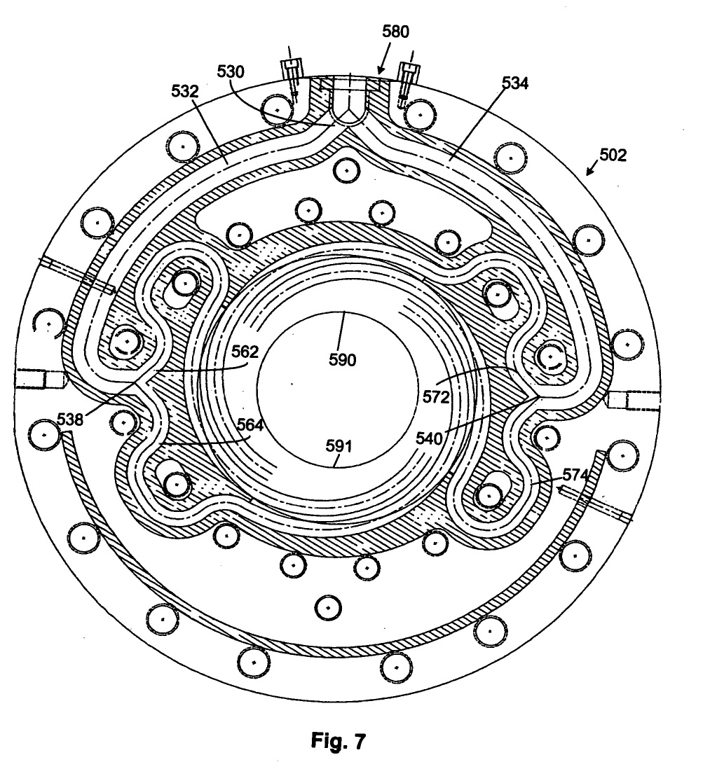

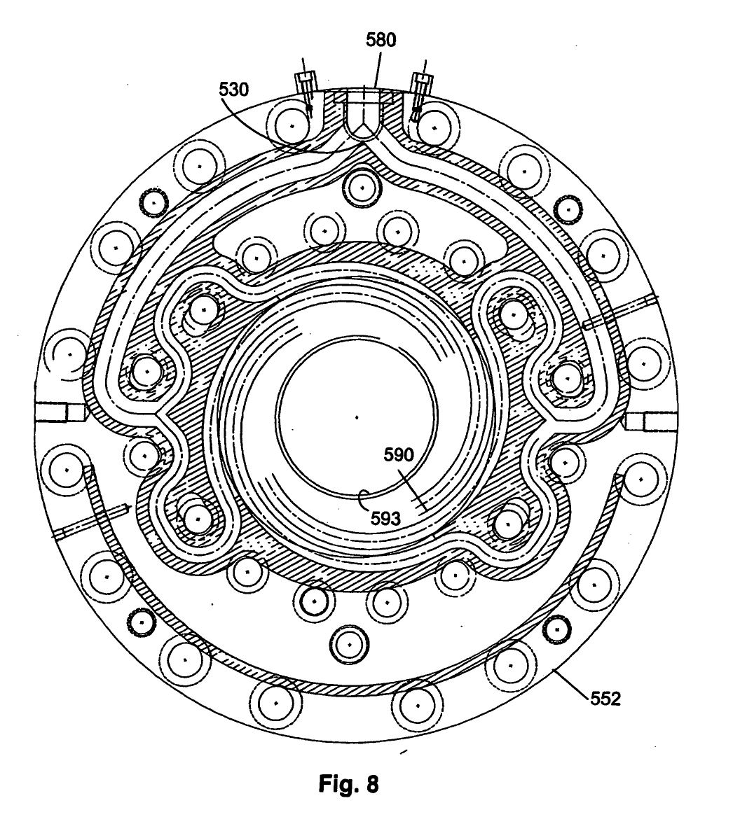

As shown in FIGS. 7 and 8 the congruent faces of the downstream face of the upstream manifold of housing 550 and the upstream face of the downstream manifold 552 of housing cooperate to present a congruent sinuous path which terminates in a circular scroll-like path 590 surrounding bore 520. Upon a contiguous connection of these faces an enclosed path results for directing the exterior resin through this sinuous path for deposit into the scroll-like outlet 590 for melding about the combined material flow at outlet 594 in communication with path 542.

An outer resin flow 1114 is delivered from Y block 1100 through restrictor 120 and into an enclosed inlet. 580 formed by the contiguous placement of the opposing downstream face of the upstream manifold 502 (FIG. 7) and the upstream face of the downstream 552 manifold (FIG. 8). In reference to FIG. 7, this outer resin flow, corresponding to the ultimate outer coating of the finished product, is directed along the sinuous path so as to assure that the resin surrounds the previously formed inner layer/foam resin combination flowing from juncture 530 and along path 542. The facing annular terminus 591, 593 of each scroll-like outlet 590 of each manifold cooperate to form an annular outlet 594 in communication with the path 542. The sinuous path assures that the resin flow time and resistance to resin flow through the sinuous path is approximately the same for all resin particles therein prior to melding about the combined material flow at juncture 594. Otherwise, undesirable gas formation, burning, stagnation and other aberration may result leading into a degraded and irregular finished product.

Accordingly, as shown in reference to FIG. 7, this outer resin flow is first directed to a first split at 530 such that this resin flow is divided equally into first 532 and second 534 paths to each side of the vertical centerline as viewed in FIG. 7. A second split occurs at 538, 540 to further divide the resin flows 532, 534 into equally resin flow paths 562, 564, 572, 574. Thus, a plurality of points of discharge of the third material about the combined flow and into scroll outlet 590 results for directing the flow to the respective termini 591, 594. Thus, a geometric balance of this resin coating about the combined flow is being achieved. Such balance enhances the uniformity of the flow which forms the outer coating of the finished product.

The plurality of termini of the above resin flow paths are then directed into the annular scroll-like path outlet 590 which progressively opens to a common annular chamber that commutes the outer resin flow towards the annular outlet 594 for a generally annular discharge of this resin flow flowing into path 542. At this juncture the outer layer annularly melds about the above-described combined layer passing through the path 542. A generally triple layer flow results and is directed downstream along path 542 to die assembly 900 which shapes the flow to a desired form—in this case a pipe having an inner resin layer, an intermediate foamed resin core and an outer resin coating.

As such, the scroll melt housing 550 is effective in first receiving the flow from a single source 580 and then directing the third material flow to a plurality of initial discharge points about the combined flow into the scroll-like path 590. This path 590 then generally annularly directs the third material in an annular flow to the annular outlet 594 for discharge of a coating about the combined flow. An exterior coating of material can be applied to any type of flow passing through the housing 550 irrespective of how the upstream material flow was produced or the number of layers therein. Thus, my scroll housing 550 can be effectively utilized in various applications with or without the upstream melt housings as above described.

Accordingly, the product has the advantage of an inner resin layer with an intermediate foamed layer constructed according to strict specifications as enhanced by the geometrically balanced flows passing through the primary and secondary melt housings. The outer resin coating can be cost-effectively applied by my novel scroll distributor housing 550 in balance about this previously formed combined material layer. The scroll-type distributor inherently has a low melt inventory thus allowing for less thermal stability of the resin so that the resin can be compounded with less cost.

It is to be understood that while a certain form of this invention has been illustrated and described, it is not limited thereto, except in so far as such limitations are included in the following claims and allowable equivalents thereof.

1. In combination with a head assembly for producing a two layer material flow, the two layer flow having a first inner layer and a second outer layer, a downstream melt distributor housing attached to said head assembly for presenting a combined material flow of said first and second layers coated with an exterior layer of material, said melt distributor housing comprising:
a first upstream housing portion;
a first channel in said first upstream housing portion adapted for a downstream flow of the fist layer of material therethrough;
a second channel in said first upstream housing portion adapted for a downstream flow of the second layer of material therethrough;
said first and second channels in said first upstream housing portion configured for melding said first and second material flows at a downstream juncture in said first housing portion, whereby to present a combined first and second material flow;
a second downstream housing portion;
channel means in said second housing portion adapted for a downstream flow of said combined first and second material flow from said juncture;
an inlet in said second housing portion for flow of a third material therethrough;
sinuous channel means in at least said second downstream housing portion and in communication with said inlet for a flow of said third material from said inlet and about said first and second combined material flow, said sinuous channel means having a downstream outlet in communication with said channel means for a melding of the third material about said combined first and second material flow through said channel means, said melding resulting in a three layer material flow, said three layer material flow comprising the first material as an interior layer, the second material as an intermediate layer and the third material as said exterior layer.

2. The device as claimed in claim 1 wherein said sinuous channel means comprises:
a sinuous path having a first end in communication with said inlet, said sinuous path having a second end adjacent said channel means having said combined first and second material flow therein;
an outlet at said second end of said sinuous path and in communication with said channel means, said outlet depositing said third material into said channel means.

3. The device as claimed in claim 2 wherein said second end of said sinuous path presents an annular scroll-like path about said channel means, said outlet presenting an annular outlet at said second end of said path in communication with said channel means for discharging the third material flow into an annular flow about the combined material flow in said channel means.

4. The device as claimed in claim 2 wherein said sinuous path comprises first and second paths having a common first end point in communication with said inlet, said paths diverging in opposed directions relative to said inlet with each of said paths presenting an outlet for discharge of the third material into said channel means at different points about the combined flow.

5. The device as claimed in claim 4 further comprising an annular scroll-like path in communication with said respective outlets of said first and second paths, said scroll-like path presenting an annular outlet for annular discharge of the third material flow about the combined material flow in said channel means.

6. The device as claimed in claim 4 wherein said first and second paths split downstream into further paths, said further paths each having an outlet for discharge of the third material at different points into said channel means containing the combined material flow.

7. The device as claimed in claim 6 further comprises a scroll-like path in communication with said respective outlets of said further paths, the third material being discharged from each respective outlet and into an annular outlet of said scroll-like path for an annular discharge of the third material about the combined material flow in said channel means.

8. In combination with an upstream head assembly producing a two layer material flow having a first interior layer and a second intermediate layer, a downstream melt distributor adapted for attachment to said head assembly for coating said two layer material flow with an exterior layer of material, said melt distributor comprising:
a housing;
a first inlet in said housing adapted for flow of the first layer of material from the upstream head assembly therethrough;
a second inlet in said housing adapted for flow of the second intermediate layer of material from the upstream-head assembly;
means in said housing for melding said first and second material flows at a downstream juncture therein, whereby to present a combined first and second material flow;
channel means in said housing adapted for passage of said combined material flow therethrough;
a third inlet in said second housing for flow of a third material therethrough;
sinuous channel means in communication with said third inlet for a flow of said third material from said third inlet and about said combined material flow in said channel means, said sinuous channel means having a downstream outlet for a melding of the third material about said combined material flow in said channel means, said melding resulting in a three layer material flow through said housing.

9. The device as claimed in claim 8 wherein said sinuous channel means comprises:
a sinuous channel path in said housing, said sinuous channel path presenting a plurality of outlets about said channel means, a discharge of the third material from said outlets of said sinuous channel path discharging the third material from said outlets and about the combined material flow.

10. The device as claimed in claim 9 further comprising an annular scroll-like path in communication with said plurality of outlets of said sinuous channel path, said scroll-like path having an outlet for discharging the material flow of the third material about the combined material flow.

11. The device as claimed in claim 9 wherein said sinuous channel paths comprises first and second paths having a starting point in communication with said third inlet, said paths diverging in opposed directions with each of said paths presenting an outlet for discharge of the third material at different points about the combined flow.

12. The device as claimed in claim 11 further comprising an annular scroll-like path in communication with said outlets of said first and second paths, said scroll-like path having an annular outlet for discharging the third material flow about the combined material flow.

13. The device as claimed in claim 11 wherein each said first and second paths split into further paths, said further paths each having an outlet for discharge of the third material at different points about the combined material flow.

14. The device as claimed in claim 13 further comprising a scroll-like path in communication with said respective outlets of said further paths, the third material being discharged from each respective outlet and into said scroll-like path, said scroll-like path having an annular outlet for discharge of the third material about the combined material flow.

15. In combination with a head assembly for providing an upstream material flow, a downstream melt distributor attached to said head assembly for coating said material flow with a layer of a second material, said melt distributor comprising:
a housing;
channel means in said housing adapted for passage of the upstream material flow therethrough;
means in said housing for initial input of a second material therein;
sinuous channel means in said housing and in communication with said input means for directing a flow of the second material about said material flow in said channel means, said sinuous channel means having a plurality of downstream outlets about the material flow for a melding of the second material with the material flow.

16. The device as claimed in claim 15 wherein said sinuous channel means comprises a sinuous path in said housing, said second path winding about said material flow and presenting a plurality of downstream outlets surrounding the material flow.

17. The device as claimed in claim 16 wherein said sinuous channel means includes an annular scroll-like path in communication with said downstream outlets of said sinuous path, said scroll-like path presenting an annular outlet for discharging the material flow of the material about the materiel flow.

18. The device as claimed in claim 16 wherein said sinuous path comprises at least first and second paths having a common starting point in communication with said input means, each said path having an outlet at different points about the material flow.

19. The device as claimed in claim 18 further comprising an annular scroll-like path in communication with each said outlet of said at least first and second paths, said scroll-like path having a generally annular outlet for discharging the second material about the material flow.

20. The device as claimed in claim 18 wherein each said first and second paths split into further paths, said further paths each having downstream outlets for discharge of the second material at a plurality of points about the material flow.
